(19) United States
(12) Patent Application Publication
(10) Pub. No.: US 2022/0067517 A1
(43) Pub. Date: Mar. 3, 2022

(54) ARTIFICIAL NEURAL NETWORK

(71) Applicant: Ford Global Technologies, LLC, Dearborn, MI (US)

(72) Inventor: Turgay Isik Aslandere, Aachen (DE)

(73) Assignee: Ford Global Technologies, LLC, Dearborn, MI (US)

(21) Appl. No.: 17/410,289

(22) Filed: Aug. 24, 2021

(30) Foreign Application Priority Data
Aug. 26, 2020 (DE) 102020210795.5

(51) Int. Cl. G06N 3/08; B60W 30/00

(52) U.S. Cl. CPC G06N 3/08; B60W 30/00

(57) ABSTRACT

An artificial neural network includes an input layer, a first intermediate layer and at least one further intermediate layer, as well as an output layer, wherein the input layer comprises a plurality of neurons, the first intermediate layer a first number of neurons and the further intermediate layer a further number of neurons, wherein the first number is greater than the further number.

### CROSS-REFERENCE TO RELATED APPLICATION

This patent application claims priority to German Application No. DE 102020210795.5 filed on Aug. 26, 2020, which is hereby incorporated by reference in its entirety.

### BACKGROUND

Artificial neural networks (ANN) are networks of artificial neurons. These neurons (or node points) of an artificial neural network are arranged in layers, and are usually connected to one another in a fixed hierarchy. The neurons here are in most cases connected between two layers, but also, in less usual cases, within one layer.

The use of a trained artificial neural network here offers the advantage of benefiting from its ability to learn, its parallel operation, its fault tolerance and its robustness in regard of malfunctions.

Artificial neural networks, such as recurrent neural networks, can thus make highly accurate predictions. Artificial neural networks that, in contrast to feedforward neural networks, are characterized by connections from neurons of one layer to neurons of the same or to a preceding layer, are referred to as recurrent neural networks (RNN).

With this kind of multilayer recurrent neural network the accuracy can be increased further if enough data is available. Particularly during the training, however, such artificial neural networks demand particularly high computing power, and have problems with a vanishing gradient.

There is thus a need to indicate ways in which the need for high computing power can be reduced.

### SUMMARY

The present disclosure relates to an artificial neural network. The artificial neural network includes an input layer, a first intermediate layer and at least one further intermediate layer, as well as an output layer, wherein the input layer comprises a plurality of neurons, the first intermediate layer a first number of neurons and the further intermediate layer a further number of neurons, wherein the first number is greater than the further number.

If the artificial neural network comprises two intermediate layers, the first intermediate layer is the layer that directly interfaces with the first intermediate layer in the direction of the output layer. The further intermediate layer, which interfaces with the output layer, then follows as the second intermediate layer. In other words, the first intermediate layer is disposed immediately adjacent to the input layer, and the further intermediate layer is disposed immediately adjacent to the output layer. If, on the other hand, the artificial neural network comprises more than two intermediate layers, the first intermediate layer can be any desired intermediate layer except for the last intermediate layer before the output layer. The further intermediate layer can interface in the direction of the output layer directly or indirectly, i.e., there can be further intermediate layers in between. The further intermediate layer can moreover also be the last intermediate layer before the output layer.

An artificial neural network with a non-uniform distribution of neurons is thus provided which, in comparison with an artificial neural network having a uniform distribution of neurons, comprises a reduced number of neurons. This reduces the need for computing power, in particular during the training of the artificial neural network.

According to one embodiment, the artificial neural network is a recurrent neural network. Artificial neural networks that, in contrast to feedforward neural networks, are characterized by connections from neurons of one layer to neurons of the same or to a preceding layer, are referred to as recurrent neural networks (RNN). In an intermediate layer that comprises fewer neurons than the previous intermediate layer, information can thus be transmitted from a neuron in this intermediate layer to a further neuron that is in this same layer. A loss of information is counteracted in this way.

According to a further embodiment, the artificial neural network has a long short-term memory (LSTM). The training results can thus be improved. In an artificial neural network with a long short-term memory of this sort, each neuron of the artificial neural network is designed as an LSTM cell with an input logic gate, a forget logic gate and an output logic gate. These logic gates store values over periods of time, and control the information flow that is provided in sequences.

According to a further embodiment, the output layer comprises a plurality of neurons. Since the input layer already comprises a plurality of neurons, the artificial neural network can also be regarded as a multivariable-to-multivariable system with a many-to-many architecture. A multivariable output signal, or a multidimensional output signal, can thus be provided with the artificial neural network.

According to a further embodiment, the output layer comprises one neuron. The artificial neural network can thus also be regarded as a multivariable-single variable system with a many-to-single architecture. A single-variable output signal, or a one-dimensional output signal, can thus be provided with the artificial neural network.

According to a further embodiment, at least one neuron of the first intermediate layer is directly connected to at least one neuron of the output layer. Information is thus transmitted directly to the output layer, circumventing further intermediate layers, without this resulting in a loss of information.

According to a further embodiment, the number of neurons falls at an essentially constant rate from the first intermediate layer to a further intermediate layer, and from the further intermediate layer to a further intermediate layer. An essentially constant rate here means a rate whose value is an integer, and the value of which is determined, if necessary, by rounding up and/or rounding down. In other words, the artificial neural network tapers in a consistent manner toward the output layer. The number of neurons, and thereby the computing effort, can thus be held particularly small, in particular when training, at the same time having an unchanged performance of the artificial neural network.

A computer program product for an artificial neural network of this type, a control unit with an artificial neural network of this type, and a motor vehicle with a control unit of this type furthermore belong to the present disclosure.

### BRIEF SUMMARY OF THE DRAWINGS

The present disclosure will now be explained with reference to drawings, in which:

FIG. 1 shows a schematic illustration of a first exemplary embodiment of an artificial neural network.

FIG. 2 shows a schematic illustration of a further exemplary embodiment of an artificial neural network.

FIG. 3 shows a schematic illustration of a further exemplary embodiment of an artificial neural network.

FIG. 4 shows a schematic illustration of a further exemplary embodiment of an artificial neural network.

FIG. 5 shows a schematic illustration of a process flow for the development of the artificial neural networks shown in FIGS. 1 to 4.

FIG. 6 shows a schematic illustration of a process flow for the training of the artificial neural networks shown in FIGS. 1 to 4.

FIG. 7 shows a schematic illustration of components of a control unit of a motor vehicle.

### DESCRIPTION

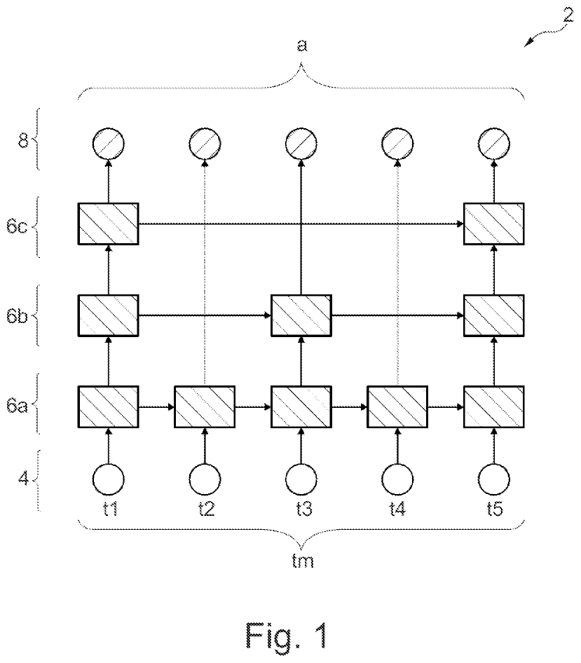

Reference is first made to FIG. 1.

An artificial neural network 2 is illustrated having, in the present exemplary embodiment, an input layer 4, a first intermediate layer 6a, a second intermediate layer 6b and an output layer 8.

The artificial neural network 2 can be formed of hardware and/or software components in this example.

In the exemplary embodiment illustrated in FIG. 1, the input layer 4 has five neurons, the first intermediate layer 6a also has five neurons, the second intermediate layer 6b has three neurons, and the output layer 8 has five neurons.

The artificial neural network 2 is thus designed as a multivariable-multivariable system with a many-to-many architecture.

The neurons of the artificial neural network 2 here in the present exemplary embodiment are designed as LSTM cells, each having an input logic gate, a forget logic gate and an output logic gate.

The artificial neural network 2 in the present exemplary embodiment is furthermore designed as a recurrent neural network (RNN), and therefore has connections from neurons of one layer to neurons of the same layer or to neurons of a previous layer.

In operation, after the artificial neural network 2 has been subjected to training, input data tm are applied to the input layer 4 at time points t1, t2, t3 . . . tk and output data a are provided.

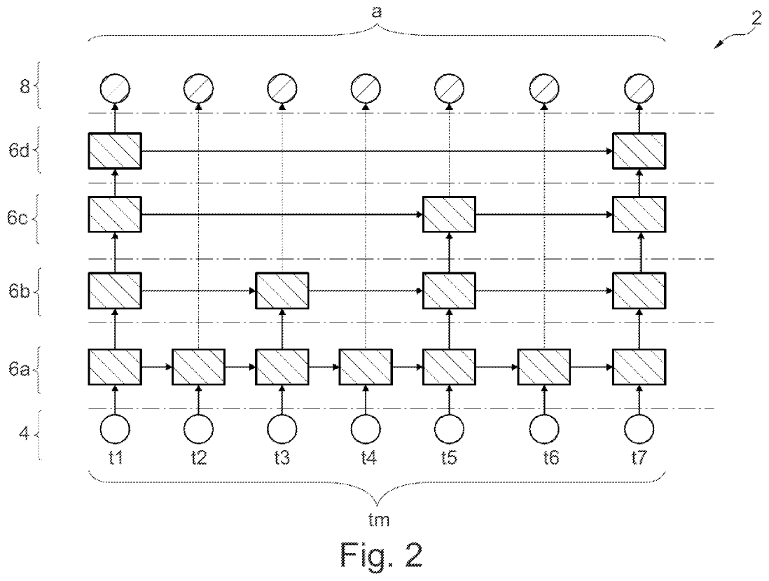

Reference is now additionally made to FIG. 2.

A further exemplary embodiment is illustrated, differing from the exemplary embodiment shown in FIG. 1 in that three intermediate layers 6a, 6b, 6c are provided between the input layer 4 and the output layer 8.

In the exemplary embodiment shown in FIG. 2, the input layer 4 has seven neurons, the first intermediate layer 6a also has seven neurons, the second intermediate layer 6b has four neurons, the third intermediate layer 6c has three neurons, the fourth intermediate layer 6d has two neurons, and the output layer 8 has seven neurons.

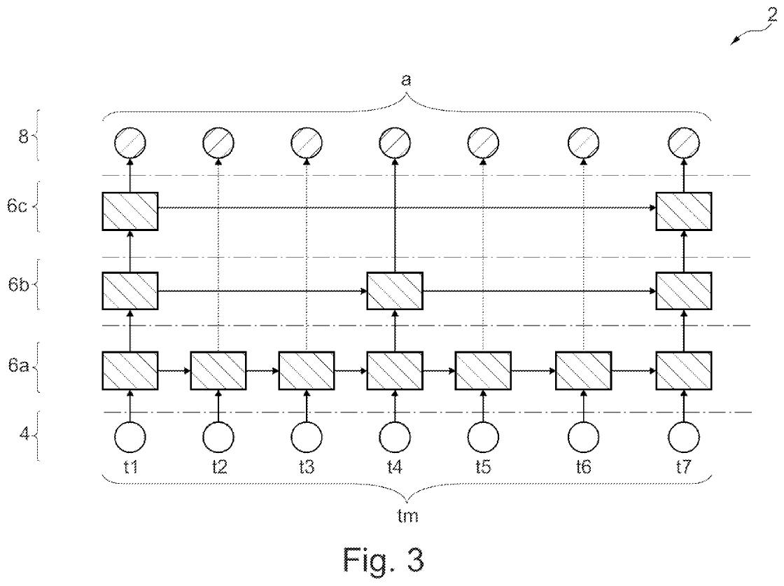

Reference is now additionally made to FIG. 3.

A further exemplary embodiment is illustrated, differing from the exemplary embodiment shown in FIG. 1 in that the input layer 4 has seven neurons, the first intermediate layer 6a also has seven neurons, the second intermediate layer 6b has three neurons, the third intermediate layer 6c has two neurons, and the output layer 8 has seve neurons n.

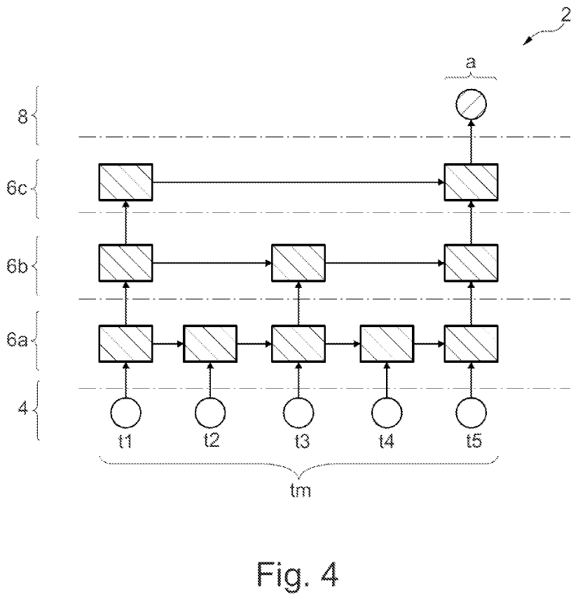

Reference is now additionally made to FIG. 4.

A further exemplary embodiment is illustrated, differing from the exemplary embodiment shown in FIG. 1 in that the input layer 4 has five neurons, the first intermediate layer 6a also has five neurons, the second intermediate layer 6b has three neurons, the third intermediate layer 6c has two neurons, and the output layer 8 has one neuron.

The artificial neural network 2 according to this exemplary embodiment is thus designed as a multivariable-single-variable system with a many-to-single architecture.

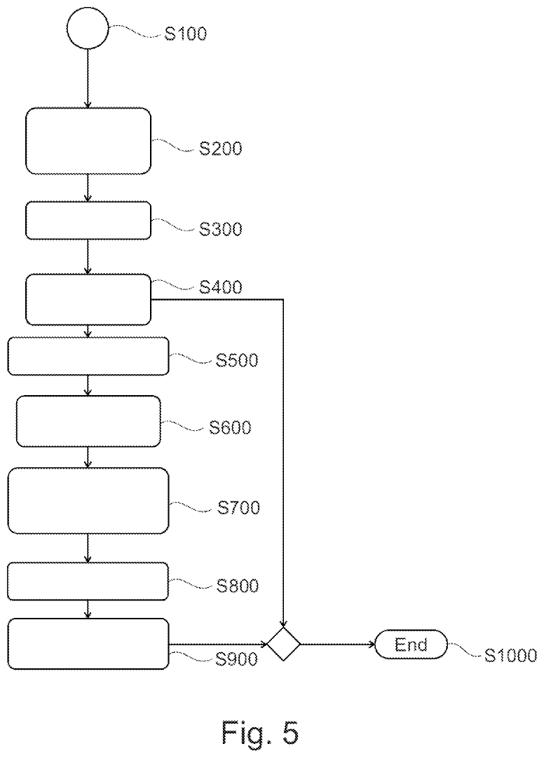

Reference is now additionally made to FIG. 5 in order to explain a process flow for the development of the artificial neural networks 2 shown in FIGS. 1 to 4.

The method can be executed here on a computer or similar computing equipment in the context of a CAE (computer-aided engineering) system that can comprise hardware and/or software components for this purpose.

The method starts in a first step S100.

Whether the artificial neural network 2 is to be designed as a multivariable-multivariable system with a many-to-many architecture, or as a multivariable-single variable system with a many-to-single architecture is specified in a further step S200.

A length k of the artificial neural network 2 is specified in a further step S300. The length k can be regarded as the number of neurons of the input layer 4.

A number n of the layers (including the input layer 4 and the output layer 8) of the artificial neural network 2 is specified in a further step S400.

A rate s by which the number of neurons should reduce from one layer to the next is specified in a further step S500.

The number cc of neurons for each of the layers, i.e. for the input layer 4, the intermediate layers 6a, 6b, 6c, 6d and the output layer 8, is specified in a further step S600.

The procedure is, for example, as follows:

Let there be cc, n, k∈Z+, where the set of integers Z comprises the number of neurons of a layer, k is the length, and n the number of layers.

The number of neurons of the first layer: cc (n=1)=length (k), n=1

The number of neurons of further layers: cc (n)=((cc(n−1)−2)/s+2), n≠1, cc (n−1)>2

For the artificial neural network 2 shown in FIG. 1: rate s=2, length K=5:
The number of neurons of the first layer cc (n=1)=k=5.
The number of neurons of the second layer cc (n=2)=((k−2)/s+2)=(5−2)/2+2=3.5=3.
The number of neurons of the third layer cc (n=3)=((cc (n=2)−2)/2)+2)=((3−2)/2+2)=2.5=2.

Since 3½ or 2½ layers are not possible, an integer conversion is provided which, in the present exemplary embodiment, results in rounding 3½ down to 3, and 2½ down to 2. Varying from the present exemplary embodiment, a rounding up can also be provided.

For the artificial neural network 2 shown in FIG. 2: rate s=2, length k=7:
The number of neurons of the first layer cc (n=1)=k=7.
The number of neurons of the second layer cc (n=2)=((k−2)/s+2)=(7−2)/2+2=4.5=4.
The number of neurons of the third layer cc (n=3)=((cc (n=2)−2)/2)+2)=((4−2)/2+2)=3.
The number of neurons of the fourth layer cc (n=4)=((cc (n=3)−2)/2)+2)=((3−2)/2+2)=2.5=2.

For the artificial neural network 2 shown in FIG. 3: rate s=3, length K=7:
The number of neurons of the first layer cc (n=1)=k=7.
The number of neurons of the second layer cc (n=2)=((k−2)/s+2)=(7−2)/3+2= 5/3+2=3⅔=3.
The number of neurons of the third layer cc (n=3)=((cc (n=2)−2)/3)+2)=((3−2)/3+2)=2+⅓=2⅓=2.

In a further step S700, the respective first and last neurons for each layer, i.e. for the input layer 4, the intermediate layers 6a, 6b, 6c, 6d and the output layer 8, are specified, and the further neurons of each layer are arranged.

The artificial neural network 2 is trained in a further step S800, as is explained later in more detail.

In a further step S900, the trained artificial neural network 2 is then brought into operation. If, however, it is found that the performance capability of the artificial neural network 2 is insufficient, a return is made to step S400 of the method. Otherwise, the method ends with a further step S1000.

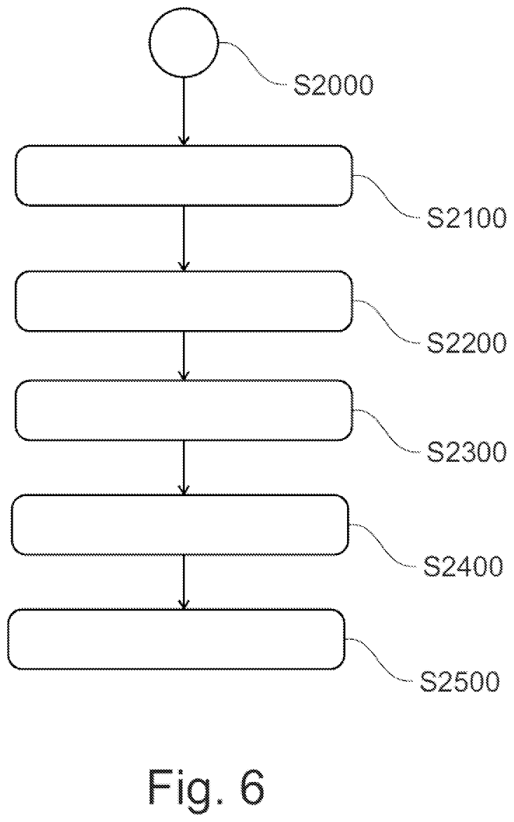

The training of the artificial neural network 2 in step S800 is now explained with reference to FIG. 6.

The training of the artificial neural network 2 starts in a first step S2000.

The artificial neural network 2 is configured in a further step S2100, for example according to the results of the method described with reference to FIG. 5.

Training data is applied to the artificial neural network 2 in a further step S2200.

Weighting factors of the neurons of the artificial neural network 2 are optimized in a further step S2300.

The artificial neural network 2 is thus modified during the training, so that it generates associated output data for specific input data tm. This can take place by means of supervised learning, unsupervised learning, reinforcing learning or stochastic learning.

Teaching the artificial neural network 2 by changing weighting factors of the neurons of the artificial neural network 2 in order to achieve the most reliable possible mapping of given training data with input data to given output data takes place, for example, by means of the method of back propagation, also known as back propagation of error.

The training can take place in a cloud environment, or off-line in a high-performance computer environment.

The artificial neural network 2, which is now trained, is provided to the application in a further step S2400.

The trained artificial neural network 2 is brought into operation, for example in a control unit 10, in a further step S2500.

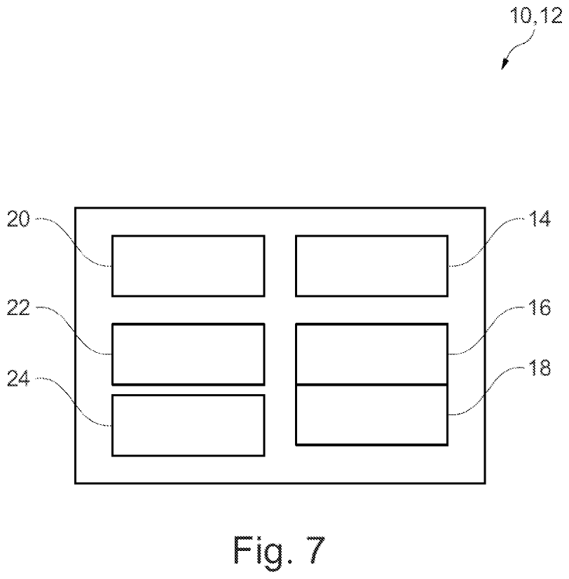

The structure of the control unit 10 is now explained with reference to FIG. 7.

The control unit 10 (or ECU: electronic control unit, or ECM: electronic control module) is an electronic module that is predominantly installed at places where something must be controlled or regulated. In the present exemplary embodiment, the control unit 10 is employed in a motor vehicle 12, such as a passenger car, and can functions of a driver assistance system or of an adaptive headlamp controller.

In the present exemplary embodiment, the control unit 10 comprises a CPU 14, a GPU 16, a main memory 18 (e.g. RAM), a further memory 20 such as SSD, HDD, flash memory and so forth, and an interface 22 such as CAN, Ethernet or Wi-Fi, as well as a CPU memory 24 as hardware components.

During a journey, i.e. when the motor vehicle 12 is operating and moving, the input data tm, provided, for example, by environmental sensors such as radar, lidar or ultrasonic sensors or cameras of the vehicle 2, are applied to the input layer 4 of the trained artificial neural network 2. Output data are provided by the output 8 and are forwarded via the interface 22 in order, for example, to drive actuators of the motor vehicle 2.

The need for computing power, in particular on the part of a control unit 10 for a motor vehicle 12, can thus be reduced.

### LIST OF REFERENCE SIGNS

2 Artificial neural network
4 Input layer
6a Intermediate layer
6b Intermediate layer
6c Intermediate layer
6d Intermediate layer
8 Output layer
10 Control unit
12 Motor vehicle
14 CPU
16 GPU
18 Main memory
20 Memory
22 Interface
24 CPU memory
a Output data
cc Number of neurons
k Length
n Number of layers
s Rate
tm Input data
t1 Time point
t2 Time point
t3 Time point
tk Time point
S100 Step
S200 Step
S300 Step
S400 Step
S500 Step
S600 Step
S700 Step
S800 Step
S900 Step
S1000 Step
S2000 Step
S2100 Step
S2200 Step
S2300 Step
S2400 Step
S2500 Step

1.-10. (canceled)

11. A system, comprising a computing apparatus programmed to:
execute an artificial neural network with an input layer, a first intermediate layer, at least one second intermediate layer, and an output layer;
wherein the input layer, the first intermediate layer, and the second intermediate layer include respective pluralities of neurons, wherein a first number of neurons in the first intermediate layer is greater than a second number of neurons on the second intermediate layer.

12. The system of claim 11, wherein the artificial neural network is a recurrent neural network.

13. The system of claim 11, wherein the artificial neural network has a long short-term memory.

14. The system of claim 11, wherein the output layer comprises a further plurality of neurons.

15. The system of claim 11, wherein the output layer comprises one neuron.

16. The system of claims 15, wherein at least one neuron of the first intermediate layer is connected directly to at least one neuron of the output layer.

17. The system of claims 15, wherein the at least one second intermediate layer includes at least three second intermediate layers, and respective numbers of neurons in the pluralities of neurons fall at an essentially constant rate from the first intermediate layer to a first second intermediate layer, and from the first second intermediate layer to a second second intermediate layer.

18. The system of claim 11, wherein the computing apparatus is a control unit for a vehicle.

19. The system of claim 18, wherein the control unit is arranged to received data from sensors of the vehicle, process the data in the artificial neural network, and out put control instructions for a driver assistance system.
